(19) United States
(12) Patent Application Publication
(10) Pub. No.: US 2025/0309972 A1
(43) Pub. Date: Oct. 2, 2025

(54) Determining Receiver Desensitization with Multi-Transmission Point Reception

(71) Applicant: Lenovo (United States) Inc., Morrisville, NC (US)

(72) Inventor: Colin FRANK, Park Ridge, IL (US)

(21) Appl. No.: 19/234,020

(22) Filed: Jun. 10, 2025

(51) Int. Cl. H04B 7/08

(52) U.S. Cl. CPC H04B 7/0851; H04B 7/0857; H04B 7/086

(57) ABSTRACT

Various aspects of the present disclosure relate to a User Equipment (UE) configured to or operable to receive, from a first transmission reception point (TRP), a first signal using a first receive beam of the UE, receive, from a second TRP, a second signal using a second receive beam of the UE, wherein the first TRP and the second TRP are located at different directions from the UE, determine a first desensitization associated with the first receive beam, determine a second desensitization associated with the second receive beam, and perform at least one of adapting at least one of the first and second receive beams to improve reception of one or both of the first signal and second signal by the UE, and communicating at least one of the first desensitization and the second desensitization to a network entity.

### TECHNICAL FIELD

The present disclosure relates to wireless communications, and more specifically to determining desensitization associated with receive beams of a UE.

### BACKGROUND

A wireless communications system may include one or multiple network communication devices, otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A UE for wireless communication is described. The UE may be configured to, capable of, or operable to receive, from a first transmission reception point (TRP), a first signal using a first receive beam of the UE, receive, from a second TRP, a second signal using a second receive beam of the UE, wherein the first TRP and the second TRP are located at different directions from the UE, determine a first desensitization associated with the first receive beam, determine a second desensitization associated with the second receive beam, and perform at least one of adapting at least one of the first and second receive beams to improve reception of one or both of the first signal and second signal by the UE, and communicating at least one of the first desensitization and the second desensitization to a network entity.

A method performed or performable by a UE for wireless communication is described. The method may include receiving, from a first transmission reception point (TRP), a first signal using a first receive beam of the UE, receiving, from a second TRP, a second signal using a second receive beam of the UE, wherein the first TRP and the second TRP are located at different directions from the UE, determining a first desensitization associated with the first receive beam, determining a second desensitization associated with the second receive beam, and performing at least one of adapting at least one of the first and second receive beams to improve reception of one or both of the first signal and second signal by the UE, and communicating at least one of the first desensitization and the second desensitization to a network entity.

In some implementations of the UE and method described herein, the one or more processors are further individually or collectively configured to cause the UE to adapt the at least one of the first and second receive beams to simultaneously reduce a first Effective Isotropic Sensitivity (EIS) for the first TRP and reduce a second EIS for the second TRP.

In some implementations of the UE and method described herein, the first desensitization and the second desensitization are based at least in part on a difference between a gain of the first receive beam in a direction of the first TRP and a gain of the first receive beam in a direction of the second TRP.

In some implementations of the UE and method described herein, difference between the gain of the first beam in the direction of the first TRP and the gain of the first beam in the direction of the second TRP is a difference between: a first EIS for the first TRP measured when the UE receives the first signal from the first TRP and does not receive the second signal from the second TRP, and a second EIS for the second TRP measured when the UE receives the second signal from the second TRP and does not receive the first signal from the first TRP.

In some implementations of the UE and method described herein, the first desensitization and the second desensitization are based at least in part on a difference between a gain of the second receive beam in the direction of the first TRP and a gain of the second receive beam in the direction of the second TRP.

In some implementations of the UE and method described herein, the first desensitization ΔEIS¹ is determined as:

$$Δ {EIS}^{1} = 10 {log}_{10} ( \frac{1 + 1 {0}^{- A / 10}}{1 - 1 {0}^{- ( A + B ) / 10}} )$$

$$where$$

$$A = {G}_{k , l} ( {ϕ}_{2} , {θ}_{2} ) - {G}_{i , j} ( {ϕ}_{2} , {θ}_{2} ) - SNR$$

$$B = {G}_{i , j} ( {ϕ}_{1} , {θ}_{1} ) - {G}_{k , l} ( {ϕ}_{1} , {θ}_{1} ) - S N R ,$$

SNR is a signal-to-noise ratio, G_{i,j}(ϕ₁, θ₁) is a gain of the first receive beam j of an antenna panel i in the direction of the first TRP, G_{i,j}(ϕ₂, θ₂) is a gain of the first receive beam in the direction of the second TRP, G_{k,l}(ϕ₁, θ₁) is a gain of the second receive beam l of an antenna panel k in the direction of the first TRP, and G_{k,l}(ϕ₂, θ₂) is a gain of the second receive beam in the direction of the second TRP.

In some implementations of the UE and method described herein, the second desensitization ΔEIS² is determined as:

$$Δ {EIS}^{1} = 10 {log}_{10} ( \frac{1 + 1 {0}^{- A / 10}}{1 - 1 {0}^{- ( A + B ) / 10}} )$$

$$where$$

$$A = {G}_{k , l} ( {ϕ}_{2} , {θ}_{2} ) - {G}_{i , j} ( {ϕ}_{2} , {θ}_{2} ) - SNR$$

$$B = {G}_{i , j} ( {ϕ}_{1} , {θ}_{1} ) - {G}_{k , l} ( {ϕ}_{1} , {θ}_{1} ) - S N R ,$$

SNR is a signal-to-noise ratio, G_{i,j}(ϕ₁, θ₁) is a gain of the first receive beam j of an antenna panel i in the direction of the first TRP, G_{i,j}(ϕ₂, θ₂) is a gain of the first receive beam in the direction of the second TRP, G_{k,l}(ϕ₁, θ₁) is a gain of the second receive beam l of an antenna panel k in the direction of the first TRP, and G_{k,l}(ϕ₂, θ₂) is a gain of the second receive beam in the direction of the second TRP.

In some implementations of the UE and method described herein, the first signal and the second signal are in frequency range FR2.

In some implementations of the UE and method described herein, the one or more processors are further individually or collectively configured to cause the UE to: measure a first reference EIS for the first TRP, and measure a second reference EIS for the second TRP, wherein the first EIS and the second EIS are measured when the UE simultaneously receives the first signal from the first TRP and the second signal from the second TRP.

In some implementations of the UE and method described herein, the one or more processors are further individually or collectively configured to cause the UE to implement a beam lock function after measuring the first reference EIS and the second reference EIS wherein the signal from the first TRP is received using the first receive beam of a first antenna panel and the signal from the second TRP is received using the second receive beam of a second antenna panel.

In some implementations of the UE and method described herein, the one or more processors are further individually or collectively configured to cause the UE to, while the beam lock function is active: measure a first EIS of the first signal from the first TRP using the first receive beam of the first antenna panel when the second signal is not being received from the second TRP, and measure a second EIS of the second signal from the second TRP using the second beam of the second antenna panel when the first signal is not being received from the first TRP.

### BRIEF DESCRIPTION OF THE DRAWINGS

FIG. 1 illustrates an example of a wireless communications system in accordance with aspects of the present disclosure.

FIG. 2 illustrates an example of multi-TRP reception by a UE in accordance with aspects of the present disclosure.

FIG. 3 illustrates an example of link desensitization of simultaneous reception of signals from two TRPs.

FIG. 4 illustrates a method for determining receiver desensitization of a UE 104 in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a NE in accordance with aspects of the present disclosure.

FIG. 8 illustrates a flowchart of method performed by a UE in accordance with aspects of the present disclosure.

### DETAILED DESCRIPTION

Aspects of the present disclosure relate to a user equipment (UE) configured to, capable of, or operable to receive signals from more than one transmission reception point (TRP). For multi-TRP reception, a signal transmitted from a first TRP de-senses, or reduces sensitivity of, the receiver for a second TRP, and a signal transmitted from the second TRP de-senses the receiver for the first TRP. Furthermore, whereas receiver desensitization due to transmissions from the UE's own transmitter is worse for weak signals for which there is a low signal-to-noise ratio (SNR), receiver desensitization due to multi-TRP reception is worse at a high SNR and places fundamental limits on performance that are not addressed by existing 3GPP core requirements. The SNR ratio requirement for conventional reference measurements used to derive core requirements is approximately 0 dB, and so the limitations due to multi-TRP interference is not observed using the existing requirements.

One or more aspects of the present disclosure relate to a UE and method for determining receiver desensitization in the high SNR region due to overlap of beams when receiving signals from at least two TRPs.

The receiver desensitization that occurs during multi-TRP reception depends on the ability of a UE to discriminate between a desired direction and an interfering direction. Measurement of a difference between beam gains allows for receiver desensitization to be computed for any target SNR without the need to directly measure the desensitization. Furthermore, these measurements can be used to determine the limiting performance for a UE. The measurement of the beam gain differences may be performed as part of Effective Isotropic Sensitivity (EIS) coverage processes. With this information, a requirement can be set on the maximum desensitization.

Aspects of the present disclosure are described in the context of a wireless communications system.

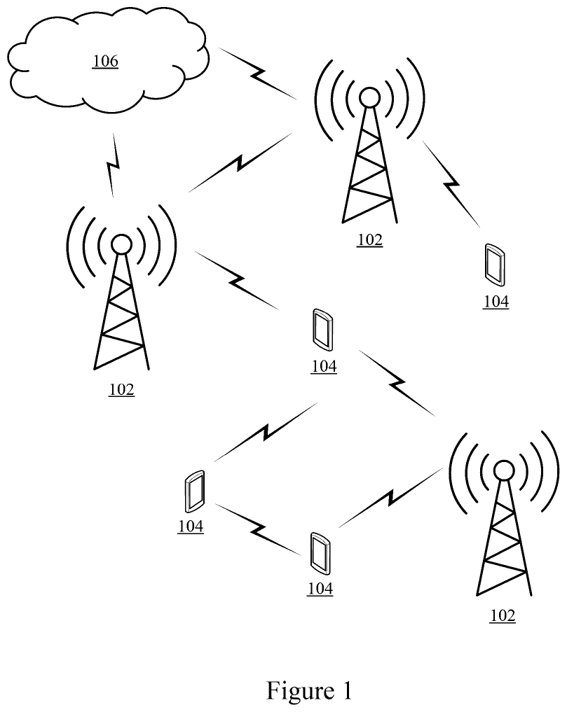

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range 1 (FR1) (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

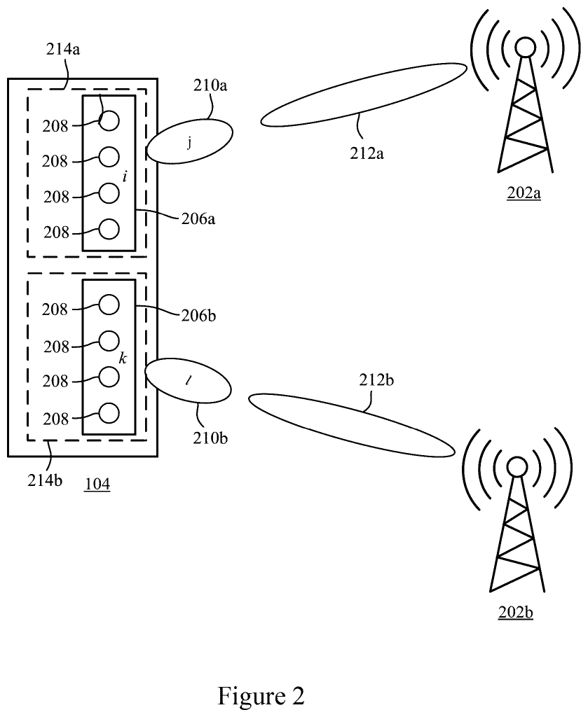

FIG. 2 illustrates an example of multi-TRP reception by a UE 104 in accordance with aspects of the present disclosure. FIG. 2 shows a UE 104 including two antenna panels 206. Each antenna panel 206 includes four antennas 208, each of which may be an antenna element. While FIG. 2 only shows a first antenna panel 206a and a second antenna panel 206b, in other implementations, a UE 104 may include three, four, or more antenna panels 206.

In some implementations, the terms antenna, panel, and antenna panel may be used interchangeably. An antenna panel 206 may be or include a hardware used for transmitting and/or receiving radio signals at frequencies lower than about 7 GHz, (e.g., frequency range 1 (FR1)), or higher than about 7 GHz, (e.g., frequency range 2 (FR2)) or millimeter wave (mmWave). In particular, aspects of the present disclosure may operate at frequencies higher than about 7 GHz including FR2.

In some implementations, an antenna panel 206 may include an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some implementations, an antenna panel 206 may or may not be virtualized as an antenna port. An antenna panel 206 may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some implementations, a device (e.g., a UE 104, or node) antenna panel 206 may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The device antenna panel 206 or “device panel” may be a logical entity with physical device antennas mapped to the logical entity. The mapping of physical device antennas 208 to the logical entity may be up to device implementation. Communicating (receiving or transmitting) on at least a subset of antenna elements or antenna ports active for radiating energy (also referred to herein as active elements) of an antenna panel 206 involves biasing or powering on of the RF chain which results in current drain or power consumption in the device associated with the antenna panel 206 (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel 206 enables generation of radiation patterns or beams.

In some implementations, depending on device's own implementation, a “device panel” can have at least one of the following functionalities as an operational role of Unit of antenna group to control its transmit beam independently, Unit of antenna group to control its transmission power independently, Unit of antenna group to control its transmission timing independently. The “device panel” may be transparent to a gNB. For certain condition(s), a gNB or network can assume the mapping between device's physical antennas 208 to the logical entity “device panel” may not be changed. For example, the condition may include until the next update or report from device or include a duration of time over which the gNB assumes there will be no change to the mapping.

A UE 104 may report its capability with respect to the “device panel” to the gNB or network. The UE 104 capability may include at least the number of “device panels”. In one implementation, the UE 104 may support UL transmission from one beam within a panel; with multiple panels, more than one beam (one beam per panel) may be used for UL transmission. In another implementation, more than one beam per panel may be supported/used for UL transmissions.

In some implementations, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial reception (Rx) parameters. Two antenna ports may be quasi-located with respect to a subset of the large-scale properties and a different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, QCL-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where the UE 104 may not be able to successfully perform omni-directional transmissions, such that the UE 104 would form beams for directional transmission. For a QCL-TypeD between two reference signals A and B, the reference signal A may conventionally be considered to be spatially co-located with reference signal B and the UE 104 may assume that the reference signals A and B can be received with the same spatial filter (e.g., with the same Rx beamforming weights). In some aspects of the present disclosure, different Rx beamforming weights may be applied by a UE 104 to receive two different reference signals and/or two different data signals (e.g., signals 212) from different TRPs 202.

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a TCI-state (Transmission Configuration Indication) associated with a target transmission can indicate parameters for configuring a quasi-collocation relationship between the target transmission (e.g., target Reference Signal (RS) of Demodulation Reference Signal (DM-RS) ports of the target transmission during a transmission occasion) and a source reference signal(s) (e.g., Synchronization Signal Block (SSB)/Channel State Information (CSI)-RS/Sounding Reference Signal (SRS)) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state includes at least one source RS to provide a reference (UE assumption) for determining QCL and/or spatial filter.

In some of the implementations described, spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some of the implementations described, a UL TCI state is provided if a device is configured with separate DL/UL TCI by Radio Resource Controller (RRC) signalling. The UL TCI state may include a source reference signal which provides a reference for determining UL spatial domain transmission filter for the UL transmission (e.g., dynamic-grant/configured-grant based Physical Uplink Shared Channel (PUSCH), dedicated Physical Uplink Control Channel (PUCCH) resources) in a CC or across a set of configured CCs/Bandwidth Parts (BWPs).

In some of the implementations described, a joint DL/UL TCI state is provided if the device is configured with joint DL/UL TCI by RRC signalling (e.g., configuration of joint TCI or separate DL/UL TCI is based on RRC signalling). The joint DL/UL TCI state refers to at least a common source reference RS used for determining both the DL QCL information and the UL spatial transmission filter. The source RS determined from the indicated joint (or common) TCI state provides a QCL Type-D indication (e.g., for device-dedicated Physical Downlink Control Channel (PDCCH)/Physical Downlink Shared Channel (PDSCH)) and is used to determine a UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

The antennas 208 may be arranged in linear arrays. In other implementations, the antennas 208 may be arranged in a different type of array such as a rectangular array. One or more antenna panel 206 of a UE 104 may have four, six, eight or more antennas 208. The antennas 208 may be spaced apart from one another at regular intervals such as one half-wavelength of an operational frequency, for example, within an antenna panel 206.

Each antenna panel 206 is associated with a respective configurable receive beam 210. In the scenario of FIG. 2, the first antenna panel 206a is associated with first receive beam 210a and the second antenna panel 206b is associated with second receive beam 210b. In addition, each antenna panel 206 may be a component of a respective receiver 214 of the UE 104. Additional components that may be present in a receiver 214 are described below with respect to receiver chains 510.

Also shown in FIG. 2 is a first TRP 202a which transmits a first signal 212a to the UE 104, and a second TRP 202b which transmits a second signal 212b to the UE 104. The signals 212 may be signals of a reference measurement channel. The reference measurement channel may be a data channel such as a PDSCH or PDCCH, for example. The first signal 212a and the second signal 212b may be transmitted using the same frequencies in the same channel. In some implementations, the signals 212 are reference signals. For example, the signals may be DM-RS or CSI-RS. The signals 212 may be beamformed signals or non-beamformed signals, and may even be omnidirectional transmissions in some implementations.

The first TRP 202a has a different location from the second TRP 202b such that the UE 104 receives the first signal 212a at a different direction from the second signal 212b. A TRP 212 may be, for example, base stations such as an eNB or gNB, an RRG, a repeater, etc. The signals 212 may have a frequency of 7 GHz or more. In some implementations, the signals 212 have frequencies in FR2.

The UE 104 may be capable of simultaneously receiving first signal 212a at first antenna panel 206a using first receive beam 210a and second signal 212b at second antenna panel 206b using second receive beam 210b. In some implementations, a UE 104 may be capable of receiving the first signal 212a and second signal 212b using a first receive beam 210a and second receive beam 210b that are associated with the same antenna panel 206. Accordingly, in some implementations, the first and second receive beams 210a and 210b are associated with the same antenna panel 206.

One or more aspects of the present disclosure address the impact of interference between the transmitted signals 212 during simultaneous reception and show that this interference results in desensitization of both receivers 214a and 214b. When first and second signals 212a and 212b are demodulated independently by a UE 104, the receiver 214 for each transmission sees the other transmission as interference. For example, if a UE 104 receives and demodulates the first signal 212a using a first receiver 214a associated with the first antenna panel 206a, and simultaneously receives and demodulates the second signal 212b using a second receiver 214b associated with the second antenna panel 206b, the first receiver 214a including first antenna panel 206a will see the second signal 212b as interference, and the second receiver 214b including second antenna panel 206b will see the first signal 212a as interference.

This interference places limits on performance that are not addressed in the existing 3GPP core requirements. The current core requirements place limits on the complementary cumulative distribution of the effective isotropic sensitivity (EIS) of the receivers when receiving simultaneously from two directions. In other words, the core requirement places a limit on the probability that the EIS of at least one of the links is greater than a value t when both links are receiving simultaneously.

In the following discussion, the first TRP 202a is located at direction (ϕ₁, θ₁) and the second TRP 202b is at direction (ϕ₂, θ₂) with respect to UE 104. In these equations, ϕ refers to an azimuth angle (horizontal direction), and θ refers to the elevation angle (vertical direction) The UE 104 minimizes an EIS for the first TRP 202a by first receive beam j 210a of first antenna panel i 206a, and similarly, the UE 104 minimizes the EIS of second TRP 202b by second receive beam l 210b of second antenna panel k 206b. Under these conditions,

$${EIS}^{1} = {EIS}_{i , j}^{1} ( {ϕ}_{1} , {θ}_{1} )$$

denotes the EIS for first TRP 202a when the UE 104 receives the first signal from the first TRP 202a and does not receive the second signal from the second TRP 202b, and similarly,

$${EIS}^{2} = {EIS}_{k , l}^{2} ( {ϕ}_{2} , {θ}_{2} )$$

denotes the EIS for second TRP 202b when the UE 104 receives the second signal 202b from the second TRP 202b and does not receive the first signal from the first TRP 202a.

The receiver noise is given by

$${σ}^{2} = {EIS}^{1} + {G}_{i , j} ( {ϕ}_{1} , {θ}_{1} ) - S N R$$

where G_{i,j}(ϕ₁, θ₁) is the gain of the j-th beam of the i-th panel in direction (ϕ₁, θ₁). Assuming the same noise figure for all beams and panels it is also true that

$${σ}^{2} = {EIS}^{2} + {G}_{k , l} ( {ϕ}_{2} , {θ}_{2} ) - S N R$$

where SNR is the signal-to-noise ratio required to achieve a given error probability for the given reference measurement channel.

With these assumptions,

$${EIS}^{1} + {G}_{i , j} ( {ϕ}_{1} , {θ}_{1} ) = {EIS}^{2} + {G}_{k , l} ( {ϕ}_{2} , {θ}_{2} ) .$$

The interference of the second signal 212b into the first receiver 214a is given by

$${σ}_{1 , 2}^{2} = {EIS}^{2} + {G}_{i , j} ( {ϕ}_{2} , {θ}_{2} ) ,$$

and similarly, the interference of the first signal 212a into the second receiver 214b is given by

$${σ}_{2 , 1}^{2} = {EIS}^{1} + {G}_{k , l} ( {ϕ}_{1} , {θ}_{1} ) .$$

It can be noted that in general,

$${σ}_{1 , 2}^{2} \neq {σ}_{2 , 1}^{2} .$$

The following discussion describes how to define receiver sensitivity when two TRPs 202 transmit simultaneously. The EIS for two TRPs 202 can be defined jointly since the power transmitted by each TRP 202 affects the interference into the receiver 214 for the other TRP 202.

Let EIS¹′ and EIS²′ denote the reference sensitivity for the first and second TRPs 202a and 202b when the UE 104 is receiving simultaneously from the first and second TRPs, and similarly, let

$${σ}_{1 , 2}^{2 ′} and {σ}_{2 , 1}^{2 ′}$$

denote the interference corresponding to EIS²′ and EIS¹′, respectively. Using this notation,

$$\begin{matrix}SNR = {EIS}^{{1}^{′}} + {G}_{i , j} ( {ϕ}_{1} , {θ}_{1} ) - 10 {log}_{10} ( {10}^{{σ}^{2} / 10} + 1 {0}^{{σ}_{1 , 2}^{{2}^{′}} / 10} ) \\ = {EIS}^{{1}^{′}} + {G}_{i , j} ( {ϕ}_{1} , {θ}_{1} ) - 10 {log}_{10} ( {10}^{( {EIS}^{1} + {G}_{i , j} ( {ϕ}_{1} , {θ}_{1} ) - S NR ) / 10} + \\ {10}^{( {E1S}^{{2}^{′}} + {G}_{i , j} ( {ϕ}_{2} , {θ}_{2} ) ) / 10} ) \\ = {EIS}^{{1}^{′}} + {G}_{i , j} ( {ϕ}_{1} , {θ}_{1} ) - 10 {log}_{10} ( {10}^{( {EIS}^{{1}^{′}} - Δ {EIS}^{1} + {G}_{i j} ( {ϕ}_{1} , {θ}_{1} ) - S NR ) / 10} + \\ {10}^{( E1 {S}^{{2}^{′}} + {G}_{i , j} ( {ϕ}_{2} , {θ}_{2} ) ) / 10} ) \\ = SNR - 10 {log}_{10} ( {10}^{- Δ {EIS}^{1} / 10} + \\ {10}^{( {EIS}^{{2}^{′}} - {EIS}^{{1}^{′}} + {G}_{i , j} ( {ϕ}_{2} , {θ}_{2} ) - {G}_{i , j} ( {ϕ}_{1} , {θ}_{1} ) + S NR ) / 10} )\end{matrix}$$

From this,

$$0 = 10 {log}_{10} ( {10}^{- Δ {EIS}^{1} / 10} + {10}^{( {EIS}^{{2}^{′}} - {EIS}^{{1}^{′}} + {G}_{i , j} ( {ϕ}_{2} , {θ}_{2} ) - {G}_{i , j} ( {ϕ}_{1} , {θ}_{1} ) + S NR ) / 10} ) \qquad ( 1 )$$

$$1 - 1 {0}^{- Δ {EIS}^{1} / 10} = {10}^{( {EIS}^{{2}^{′}} - {EIS}^{{1}^{′}} + {G}_{i , j} ( {ϕ}_{2} , {θ}_{2} ) - {G}_{i , j} ( {ϕ}_{1} , {θ}_{1} ) + S NR ) / 10}$$

$$10 {log}_{10} ( 1 - 1 {0}^{- Δ {EIS}^{1} / 10} ) = {EIS}^{{2}^{′}} - {EIS}^{{1}^{′}} + {G}_{i , j} ( {ϕ}_{2} , {θ}_{2} ) - {G}_{i , j} ( {ϕ}_{1} , {θ}_{1} ) + SNR$$

$$and finally ,$$

$$10 {log}_{10} ( 1 - 1 {0}^{- Δ {EIS}^{1} / 10} ) = {EIS}^{2} - {EIS}^{1} + Δ {EIS}^{2} - Δ {EIS}^{1} + {G}_{i , j} ( {ϕ}_{2} , {θ}_{2} ) - {G}_{i , j} ( {ϕ}_{1} , {θ}_{1} ) + SNR ,$$

where we define ΔEIS¹=EIS¹′−EIS¹ and ΔEIS²=EIS²′−EIS².

Similarly, for the second TRP 202b,

$$10 {log}_{10} ( 1 - 1 {0}^{- Δ {EIS}^{2} / 10} ) = {EIS}^{1} - {EIS}^{2} + Δ {EIS}^{1} - Δ {EIS}^{2} + {G}_{k , l} ( {ϕ}_{1} , {θ}_{1} ) - {G}_{k , l} ( {ϕ}_{2} , {θ}_{2} ) + SNR \qquad ( 2 )$$

Using the fact that

$${G}_{i , j} ( {ϕ}_{1} , {θ}_{1} ) - {G}_{k , l} ( {ϕ}_{2} , {θ}_{2} ) = {EIS}^{2} - {EIS}^{1}$$

expression (1) can be simplified as

$$Δ {EIS}^{2} = 10 {log}_{10} ( 1 - 1 {0}^{- Δ {EIS}^{1} / 10} ) + Δ {EIS}^{1} + {G}_{k , l} ( {ϕ}_{2} , {θ}_{2} ) - {G}_{i , j} ( {ϕ}_{2} , {θ}_{2} ) - SNR \qquad ( 3 )$$

so that ΔEIS² can be expressed in terms of ΔEIS¹. Similarly, (2) can be simplified as

$$Δ {EIS}^{1} = 10 ( 1 - 1 {0}^{- Δ {EIS}^{2} / 10} ) + Δ {EIS}^{2} + {G}_{i , j} ( {ϕ}_{1} , {θ}_{1} ) - {G}_{k , l} ( {ϕ}_{1} , {θ}_{1} ) - SNR \qquad ( 4 )$$

and ΔEIS¹ can be expressed in terms of ΔEIS². Finally, summing (1) and (2) yields the expression

$$10 {log}_{10} ( 1 - 1 {0}^{- Δ {EIS}^{2} / 10} ) + 10 {log}_{10} ( 1 - 1 {0}^{- Δ {EIS}^{1} / 10} ) = 2 SNR + ( {G}_{i , j} ( {ϕ}_{2} , {θ}_{2} ) - {G}_{i , j} ( {ϕ}_{1} , {θ}_{1} ) ) + ( {G}_{k , l} ( {ϕ}_{1} , {θ}_{1} ) - {G}_{k , l} ( {ϕ}_{2} , {θ}_{2} ) ) . \qquad ( 5 )$$

The expression in (5) gives the relationship between ΔEIS¹ and ΔEIS² as a function of the required signal-to-noise ratio for the link, the difference between the interference and signal seen by the first receiver 214a, G_{i,j}(ϕ₂, θ₂)−G_{i,j}(ϕ₁, θ₁), and the difference between the interference and signal seen by the second receiver 214b,

$${G}_{{k}_{,} l} ( {ϕ}_{1} , {θ}_{1} ) - {G}_{k , l} ( {ϕ}_{2} , {θ}_{2} ) .$$

A sufficient condition for ΔEIS¹=ΔEIS² is that

$${G}_{i , j} ( {ϕ}_{1} , {θ}_{1} ) = {G}_{k , l} ( {ϕ}_{2} , {θ}_{2} )$$

$$and$$

$${G}_{i , j} ( {ϕ}_{2} , {θ}_{2} ) = {G}_{k , l} ( {ϕ}_{1} , {θ}_{1} ) .$$

For this special case, (5) yields

$$Δ {EIS}^{1} = Δ {EIS}^{2} = - 10 {log}_{10} ( 1 - 1 {0}^{Z / 20} )$$

$$where$$

$$Z = - 2 SNR + ( {G}_{i , j} ( {ϕ}_{1} , {θ}_{1} ) - {G}_{i , j} ( {ϕ}_{2} , {θ}_{2} ) ) + ( {G}_{k , l} ( {ϕ}_{2} , {θ}_{2} ) - {G}_{k , l} ( {ϕ}_{1} , {θ}_{1} ) ) .$$

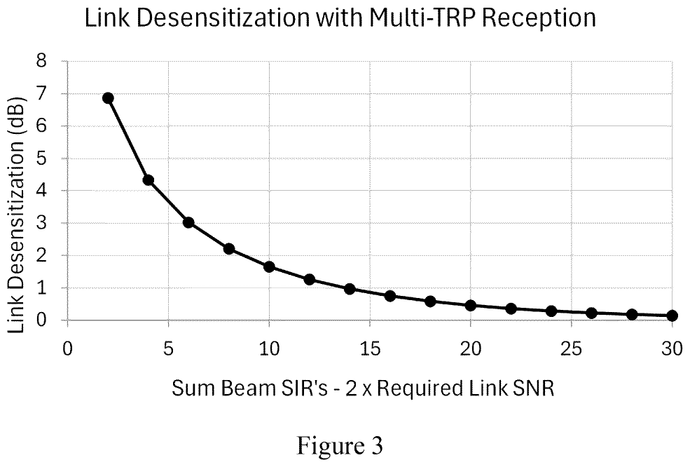

FIG. 3 illustrates an example of link desensitization of simultaneous reception of signals 212 from two TRPs 202 as a function of Z, where Z is the sum of the signal-to-interference ratios for each of the signals minus twice the required signal-to-noise ratio for the link. It can be observed that as this sum approaches zero, the required signal-to-noise ratio for the link is no longer achievable and the desensitization of the link increases without bound.

For the more general case in which ΔEIS¹≠ΔEIS², it is necessary to solve for ΔEIS¹ and ΔEIS² explicitly. Expressions (3) and (4) can be rewritten as

$$Δ {EIS}^{2} = 10 {log}_{10} ( 1 - 1 {0}^{- Δ {EIS}^{1} / 10} ) + Δ {EIS}^{1} + A \qquad ( 6 )$$

so that ΔEIS² can be expressed in terms of ΔEIS¹. Similarly, (2) can be simplified as

$$Δ {EIS}^{1} = 10 {log}_{10} ( 1 - 1 {0}^{- Δ {EIS}^{2} / 10} ) + Δ {EIS}^{2} + B \qquad ( 7 )$$

where A and B are defined as

$$A = {G}_{k , l} ( {ϕ}_{2} , {θ}_{2} ) - {G}_{i , j} ( {ϕ}_{2} , {θ}_{2} ) - SNR$$

$$B = {G}_{i , j} ( {ϕ}_{1} , {θ}_{1} ) - {G}_{k , l} ( {ϕ}_{1} , {θ}_{1} ) - SNR .$$

Substituting for ΔEIS¹ in (6) yields

$$\begin{matrix}Δ {EIS}^{2} = 10 {log}_{10} ( 1 - 1 {0}^{- ( 10 {log}_{10} ( 1 - 1 {0}^{- Δ {EIS}^{2} / 10} ) + Δ {EIS}^{2} + B ) / 10} ) \\ + 10 {log}_{10} ( 1 - 1 {0}^{- Δ {EIS}^{2} / 10} ) + Δ {EIS}^{2} + A + B\end{matrix}$$

Simplifying results in:

$$\begin{matrix}0 = 10 {log}_{10} ( 1 - \frac{1 {0}^{- ( Δ {EIS}^{2} + B ) / 10}}{1 - 1 {0}^{- Δ {EIS}^{2} / 10}} ) + 10 {log}_{10} ( 1 - 1 {0}^{- Δ {EIS}^{2} / 10} ) + A + B \\ - \frac{( A + B )}{10} = {log}_{10} ( 1 - 1 {0}^{- Δ {EIS}^{2} / 10} - 1 {0}^{- ( Δ {EIS}^{2} + B ) / 10} ) \\ 1 {0}^{- ( B + A ) / 10} = 1 - 1 {0}^{- Δ {EIS}^{2} / 10} - {10}^{- ( Δ {EIS}^{2} + B ) / 10} \\ 1 {0}^{- Δ {EIS}^{2} / 10} + {10}^{- ( Δ {EIS}^{2} + B ) / 10} = 1 - {10}^{- ( A + B ) / 10} \\ 1 {0}^{- Δ {EIS}^{2} / 10} ( 1 + {10}^{- B / 10} ) = 1 - {10}^{- ( A + B ) / 10} \\ 1 {0}^{- Δ {EIS}^{2} / 10} = \frac{1 - {10}^{- ( A + B ) / 10}}{1 + {10}^{- B / 10}} \\ Δ {EIS}^{2} = - 10 {log}_{10} ( \frac{1 - {10}^{- ( A + B ) / 10}}{1 + {10}^{- B / 10}} )\end{matrix}$$

$$In summary ,$$

$$Δ {EIS}^{1} = - 10 {log}_{10} ( \frac{1 + {10}^{- A / 10}}{1 - {10}^{- ( A + B ) / 10}} ) \qquad ( 8 )$$

$$Δ {EIS}^{2} = - 10 {log}_{10} ( \frac{1 + {10}^{- B / 10}}{1 - {10}^{- ( A + B ) / 10}} ) \qquad ( 9 )$$

$$where$$

$$A = {G}_{k , l} ( {ϕ}_{2} , {θ}_{2} ) - {G}_{i , j} ( {ϕ}_{2} , {θ}_{2} ) - SNR \qquad ( 10 )$$

$$B = {G}_{i , j} ( {ϕ}_{1} , {θ}_{1} ) - {G}_{k , l} ( {ϕ}_{1} , {θ}_{1} ) - SNR . \qquad ( 11 )$$

When a receiver 214 of a UE 104 is desensed due to self-interference from the UE's own transmitter, the desensitization only occurs when the power of the received signal is near the noise floor of the receiver. As a result, desensitization due to self-interference typically occurs when the UE 104 is at the edge of a cell and the received signal is weak. As the received signal becomes stronger, desensitization due to self-interference becomes less and less significant.

Self-interference in the UE 104 generated by the UE's transmitter can take the form of transmitter harmonics, intermodulation products, or leakage from the transmitter in one band to the receiver in another band. During frequency division duplex (FDD) operation, the transmitter can de-sense the receiver 214 in the same band as a result of the limited filter rejection of the duplex filter that protects the receive spectrum from the transmit spectrum.

The desensitization that occurs for a UE 104 receiving from multiple TRPs 202 simultaneously and demodulated independently is fundamentally different than the desensitization that occurs due to self-interference from the UE's transmitter. The first signal 212a is interference into second receiver 214b for the second signal 212b, and the second signal 212b is interference into the first receiver 214a for the first signal 212a. Thus, while the ratio of the signal power to receiver noise increases with transmitter power, the ratio of the power of the received signal 212a from first TRP 202a to interference from the received signal 212b from second TRP 202b is independent of the receiver noise power.

To illustrate the limits on the achievable signal-to-noise ratio with inter-TRP interference, the following discussion presents a hypothetical case in which there is no receiver thermal noise. For this limiting case, the signal to interference ratio for the first and second TRPs 202a and 202b are given by

$$\begin{matrix}SNR = {EIS}^{{1}^{′}} + {G}_{i , j} ( {ϕ}_{1} , {θ}_{1} ) - ( {EIS}^{{2}^{′}} + {G}_{i , j} ( {ϕ}_{2} , {θ}_{2} ) ) \\ SNR = {EIS}^{{2}^{′}} + {G}_{k , l} ( {ϕ}_{2} , {θ}_{2} ) - ( {EIS}^{{1}^{′}} + {G}_{k , l} ( {ϕ}_{1} , {θ}_{1} ) )\end{matrix}$$

where, as above, EIS¹′ and EIS²′ denote the reference sensitivity when the UE 104 is receiving from these two TRPs 202 simultaneously. This system of two equations can be rewritten as

$$\begin{matrix}{EIS}^{{1}^{′}} - {EIS}^{{2}^{′}} = SNR - {G}_{i , j} ( {ϕ}_{1} , {θ}_{1} ) + {G}_{i , j} ( {ϕ}_{2} , {θ}_{2} ) \\ - {EIS}^{{1}^{′}} + {EIS}^{{2}^{′}} = SNR - {G}_{k , l} ( {ϕ}_{2} , {θ}_{2} ) + {G}_{k , l} ( {ϕ}_{1} , {θ}_{1} )\end{matrix}$$

Because the determinant of the matrix

$$[ \begin{matrix}1 & - 1 \\ - 1 & 1\end{matrix} ]$$

is zero, this set of equations either has no solution or an infinite number of solutions. In particular, it can be shown that a solution exists only in the case that

$$SNR = \frac{( {G}_{i , j} ( {ϕ}_{1} , {θ}_{1} ) - {G}_{i , j} ( {ϕ}_{2} , {θ}_{2} ) ) + ( {G}_{k , l} ( {ϕ}_{2} , {θ}_{2} ) - {G}_{k , l} ( {ϕ}_{1} , {θ}_{1} ) )}{2} .$$

In this case, there is an infinite set of solutions (EIS¹′, EIS²′) which satisfy the requirement that

$$\begin{matrix}{EIS}^{{1}^{′}} - {EIS}^{{2}^{′}} = SNR - {G}_{i , j} ( {ϕ}_{1} , {θ}_{1} ) + {G}_{i , j} ( {ϕ}_{2} , {θ}_{2} ) \\ = \frac{{G}_{k , l} ( {ϕ}_{2} , {θ}_{2} ) - {G}_{k , l} ( {ϕ}_{1} , {θ}_{1} )}{2} . \\ Thus , any pair of values ( {EIS}^{{1}^{′}} , {EIS}^{{2}^{′}} ) is a solution so long as\end{matrix}$$

$${EIS}^{{1}^{′}} - {EIS}^{{2}^{′}} = \frac{{G}_{k , l} ( {ϕ}_{2} , {θ}_{2} ) - {G}_{k , l} ( {ϕ}_{1} , {θ}_{1} )}{2} , \qquad ( 12 )$$

$$and$$

$$SNR = \frac{( {G}_{i , j} ( {ϕ}_{1} , {θ}_{1} ) - {G}_{i , j} ( {ϕ}_{2} , {θ}_{2} ) ) + ( {G}_{k , l} ( {ϕ}_{2} , {θ}_{2} ) - {G}_{k , l} ( {ϕ}_{1} , {θ}_{1} ) )}{2} . \qquad ( 13 )$$

For any other pair of values (EIS¹′, EIS²′) such that Equation (12) is not satisfied, the signal-to-interference ratio for one TRP 202 will be greater than the value (13), and the signal-to-interference ratio will be less than the value (13).

The SNR (13) corresponds to the difference of the beam gain in the direction of the desired signal and the direction of an interfering signal averaged over the two receive beams 210 and is an upper bound on the signal-to-noise ratio that can be achieved in the absence of receiver noise. This SNR value is an important metric for any pair of directions (ϕ₁, θ₁) and (ϕ₂, θ₂). However, since reference sensitivity is normally defined for reference measurement channels for which the SNR requirement is low (e.g., 0 dB), the inability of the UE 104 to achieve higher signal-to-noise ratios regardless of TRP transmission powers will not be observed. The inability of the existing EIS measurements to identify limits on link performance is a limitation on the existing method.

The following discussion addresses the reference sensitivity for a direction (ϕ₁, θ₁) and the joint reference sensitivity for a pair of directions (ϕ₁, θ₁) and (ϕ₂, θ₂).

Reference Sensitivity for Single TRP Reception at (ϕ₁, θ₁): For a reference measurement channel defined by a specific Modulation and Coding Scheme (MCS) and a corresponding error rate requirement, the reference sensitivity for a given direction (ϕ₁, θ₁) is denoted as EIS(ϕ₁, θ₁) and is the minimum effective isotropic power at which the received error rate meets the error rate requirement.

Reference Sensitivity for Simultaneous Reception from Two TRPs at (ϕ₁, θ₁) and (ϕ₂, θ₂): For a reference measurement channel defined by a specific MCS and a corresponding error rate requirement, the reference sensitivity for a pair of directions (ϕ₁, θ₁) and (ϕ₂, θ₂) is denoted as the ordered pair (EIS(ϕ₁, θ₁), EIS(ϕ₂, θ₂)) of effective isotropic power values at which the received error rates for the transmissions 212 from the two TRPs 202, received simultaneously and demodulated independently, meet the error rate requirement. If such an ordered pair exists, it is given by equations (8), (9), (10), and (11).

Feasible Region for Simultaneous Reception from Two TRPs at (ϕ₁, θ₁) and (ϕ₂, θ₂): For a reference measurement channel defined by a specific MCS and a corresponding error rate requirement, the feasible region of the reference sensitivity for a pair of directions (ϕ₁, θ₁) and (ϕ₂, θ₂) is denoted as the set of ordered pairs of effective isotropic power values {(EIP(ϕ₁, θ₁), EIP(ϕ₂, θ₂))} for which the received error rates for the transmissions from the two TRPs, received simultaneously and demodulated independently, are less than or equal to the error rate requirements.

In a scenario in which the signal carried by first signal 212a from the first TRP 202a is interference into the second receiver 214b (which demodulates second signal 212b from second TRP 202b), and likewise, the signal carried by second signal 212b from the second TRP 202b is interference into the receiver 214a (which demodulates first signal 212a from first TRP 202a), if the power transmitted by either TRP 202 is increased, it may generate sufficient interference into the receiver 214 for the other TRP 202 that the signal-to-noise ratio for the other TRP 202 falls below threshold requirements, e.g., error rate requirements, for signal demodulation. Put another way, increasing the transmit power of either TRP 202 in this scenario could cause so much interference to signals from the other TRP 202 that a UE 104 may not be able to successfully demodulate its transmissions. Accordingly, it is apparent that increasing transmit power for a TRP 202 is not by itself an effective measure.

The following equations consider how to define a change (ΔEIP¹, ΔEIP²) of the effective isotropic power (EIP¹, EIP²) such that the signal-to-noise ratio for both signals 212a and 212b received from first and second TRPs 202a and 202b increases. Below, σ² denotes the power of the UE 104 receiver noise. In order for the SNR of the first TRP 202a to increase with the change (ΔEIP¹, ΔEIP²), it is apparent that

$$\begin{matrix}Δ {EIP}^{1} - 10 {log}_{10} ( \frac{{σ}^{2} + {10}^{( {EIP}^{2} + Δ {EIP}^{2} + {G}_{i , j} ( {ϕ}_{2} , {θ}_{2} ) ) / 10 )}}{{σ}^{2} + {10}^{( {EIP}^{2} + {G}_{i , j} ( {ϕ}_{2} , {θ}_{2} ) ) / 10}} ) \geq 0 \\ 1 {0}^{Δ {EIP}^{1} / 10} \geq \frac{{σ}^{2} + {10}^{( {EIP}^{2} + Δ {EIP}^{2} + {G}_{i , j} ( {ϕ}_{2} , {θ}_{2} ) ) / 10}}{{σ}^{2} + {10}^{( {EIP}^{2} + {G}_{i , j} ( {ϕ}_{2} , {θ}_{2} ) ) / 10}} \\ {σ}^{2} 1 {0}^{Δ {EIP}^{1} / 10} + {10}^{( {EIP}^{2} + Δ {EIP}^{1} + {G}_{i , j} ( {ϕ}_{2} , {θ}_{2} ) ) / 10} \geq {σ}^{2} + {10}^{( {EIP}^{2} + Δ {EIP}^{2} + {G}_{i , j} ( {ϕ}_{2} , {θ}_{2} ) ) / 10} \\ {σ}^{2} ( 1 {0}^{Δ {EIP}^{1}} - 1 ) \geq {10}^{( {EIP}^{2} + {G}_{i , j} ( {ϕ}_{2} , {θ}_{2} ) ) / 10} ( 1 {0}^{Δ {EIP}^{2} / 10} - 1 {0}^{Δ {EIP}^{1} / 10} ) \\ {σ}^{2} 1 {0}^{- {G}_{i , j} ( {ϕ}_{2} , {θ}_{2} ) / 10} \geq \frac{1 {0}^{{EIP}^{2} / 10} ( 1 {0}^{Δ {EIP}^{2} / 10} - 1 {0}^{Δ {EIP}^{1} / 10} )}{1 {0}^{Δ {EIP}^{1} / 10} - 1} .\end{matrix}$$

This expression assumes that ΔEIP¹>0 as otherwise the inequality must be reversed with division by 10^{ΔEIP}^{¹}^{/10}−1. Reversing the inequality, this expression can be written as

$$\frac{1 {0}^{{EIP}^{2} / 10} ( 1 {0}^{Δ {EIP}^{2} / 10} - 1 {0}^{Δ {EIP}^{1} / 10} )}{1 {0}^{Δ {EIP}^{1} / 10} - 1} \leq {σ}^{2} 1 {0}^{- {G}_{i , j} ( {ϕ}_{2} , {θ}_{2} ) / 10} \qquad ( 14 )$$

Similarly, it can be shown that in order for the SNR of the second TRP 202b to increase with the change (ΔEIP¹, ΔEIP²),

$$\frac{{10}^{{EIP}^{1} / 10} ( {10}^{Δ {EIP}^{1} / 10} - {10}^{Δ {EIP}^{2} / 10} )}{{10}^{Δ {EIP}^{2} / 10} - 1} \leq {σ}^{2} 1 {0}^{- {G}_{k , l} ( {ϕ}_{1} , {θ}_{1} ) / 10} \qquad ( 15 )$$

It can be observed that both inequalities (12) and (13) are satisfied and the SNR for both TRPs 202a and 202b increases if ΔEIP¹>0 and ΔEIP¹=ΔEIP². However, it can also be observed that if ΔEIP² satisfies

$$1 {0}^{Δ {EIP}^{2} / 10} > {σ}^{2} {10}^{- ( {EIP}^{2} + {G}_{i , j} ( {ϕ}_{2} , {θ}_{2} ) ) / 10} ( 1 {0}^{Δ {EIP}^{1} / 10} - 1 ) + 1 {0}^{Δ {EIP}^{1} / 10} ,$$

then the SNR of the first TRP 202a decreases. Similarly, if ΔEIP² satisfies

$$1 {0}^{Δ {EIP}^{1} / 10} > {σ}^{2} 1 {0}^{- ( {EIP}^{1} + {G}_{k , l} ( {ϕ}_{1} , {θ}_{1} ) ) / 10} ( 1 {0}^{Δ {EIP}^{2} / 10} - 1 ) + 1 {0}^{Δ {EIP}^{2} / 10} ,$$

then the SNR of the second TRP 202b decreases.

As discussed herein, for multi-TRP reception by the same UE 104, the signal transmitted from the first TRP 202a de-senses the receiver 214b for the second TRP 202b and the signal transmitted from the second TRP 202b de-senses the receiver 214a for the first TRP 202a. Furthermore, whereas receiver desensitization due to the UE's own transmitter is worst for weak signals, receiver desensitization due to multi-TRP reception is worst at high signal-to-noise ratio and places fundamental limits on performance that are not addressed by the existing 3GPP core requirements. The signal-to-noise ratio requirement for the current reference measurement used to derive core requirements is approximately 0 dB, and so the limitations due to multi-TRP interference will not be observed and are not addressed in the existing core requirements.

As indicated in the analysis herein, the receiver desensitization that occurs during multi-TRP reception depends on the ability of the receive beams 210 of a UE 104 to discriminate between the desired direction, e.g., the direction of a first TRP 202a which transmits a signal that is demodulated by a first receiver 214a associated with a first receive beam 210a, and the interfering direction, e.g., the direction of a second TRP 202b which transmits another signal 212b that is being demodulated by a second receiver 214b of the same UE 104. For a first signal 212a received by the j-th receive beam 210 of the i-th antenna panel 206, this ability to discriminate is captured by the difference in gain

$${G}_{i , j} ( {ϕ}_{1} , {θ}_{1} ) - {G}_{i , j} ( {ϕ}_{2} , {θ}_{2} )$$

where (ϕ₁, θ₁) is the direction of the first TRP 202a and (ϕ₂, θ₂) is the direction of the second TRP 202b from the UE 104. Similarly, for the second signal 212b received by the l-th receive beam 210 of the k-th antenna panel 214, this ability to discriminate is captured by the difference in gain

$${G}_{k , l} ( {ϕ}_{2} , {θ}_{2} ) - {G}_{k , l} ( {ϕ}_{1 ′} {θ}_{1} ) .$$

These two differences are used in expressions 1-5, 12, and 13 in the discussion herein to evaluate the receiver desensitization. Additionally, the differences

$${G}_{i , j} ( {ϕ}_{1} , {θ}_{1} ) - {G}_{k , l} ( {ϕ}_{1} , {θ}_{1} )$$

$$and$$

$${G}_{k , l} ( {ϕ}_{2} , {θ}_{2} ) - {G}_{i , j} ( {ϕ}_{2} , {θ}_{2} )$$

are used in expressions 6-11 to evaluate receiver desensitization. In particular, equations 8 and 9 give the receiver desensitization for each of the TRPs 202 as a function of only the gain differences and the target SNR. Thus, once these antenna gain differences are known, they can be used to determine the receiver desensitization for any reference measurement channel (any modulation and coding rate), so long as a target SNR is known.

In summary, in aspects of the present disclosure, measurement of the difference between the beam gains may allow the receiver desensitization to be determined for any target SNR without the need to directly measure desensitization, for example by measuring a receiver's ability to successfully demodulate a weak signal in the presence of a stronger interfering signal. Furthermore, these measurements can be used to determine limits on performance for the UE 104.

Conventionally, RAN4 only measures EIS jointly for simultaneous reception for a reference measurement channel for which the SNR requirement is approximately 0 dB when receiving from a single TRP 202. For this reference measurement channel, the impact of interference between simultaneously transmitting TRPs 202 is minimal and the impact of this interference on performance at higher signal-to-noise ratios will not be observed.

To evaluate the impact of receiver beam design on receiver desensitization, aspects of the present disclosure may evaluate the performance of simultaneously receiving signals 212a and 212b of one or more reference measurement channels for which the signal-to-noise ratio requirement is substantially higher than conventional solutions.

In a first implementation, EIS measurements may be taken by a UE 104 of signals 212a and 212b of at least two different reference measurement channels. For example, the UE 104 may perform EIS measurements of simultaneously received signals 212a and 212b which are of a first reference measurement channel for which the SNR requirement is a first level (e.g., 0 dB), and perform EIS measurements of simultaneously received signals 212a and 212b of a second reference measurement channel for which the SNR requirement is at least 10 dB. In some implementations, the SNR requirement of the second reference measurement channel is in excess of 20 dB. In some implementations, the UE 104 may communicate the measurement data to the network by transmitting a signal to an NE 102, which may be a TRP 202. These measurements may be used to define limits on the complementary cumulative distribution of the EIS of the UE 104 when receiving simultaneously from two directions for these additional reference measurement channels. This information is useful in understanding the throughput limitations of the device in environments in which the UE 104 is near to the TRPs so that high signal-to-noise ratios are achievable.

In a second implementation, a UE 104 measures the following beam gain differences:

$$\begin{matrix}{G}_{i , j} ( {ϕ}_{1} , {θ}_{1} ) - {G}_{i , j} ( {ϕ}_{2} , {θ}_{2} ) \\ {G}_{k , l} ( {ϕ}_{2} , {θ}_{2} ) - {G}_{k , l} ( {ϕ}_{1} , {θ}_{1} ) \\ {G}_{i , j} ( {ϕ}_{1} , {θ}_{1} ) - {G}_{i , j} ( {ϕ}_{1} , {θ}_{1} ) \\ {G}_{k , l} ( {ϕ}_{2} , {θ}_{2} ) - {G}_{i , j} ( {ϕ}_{2} , {θ}_{2} )\end{matrix}$$

and determines receiver desensitization based on the relationships described herein with respect to equations 1 to 13.

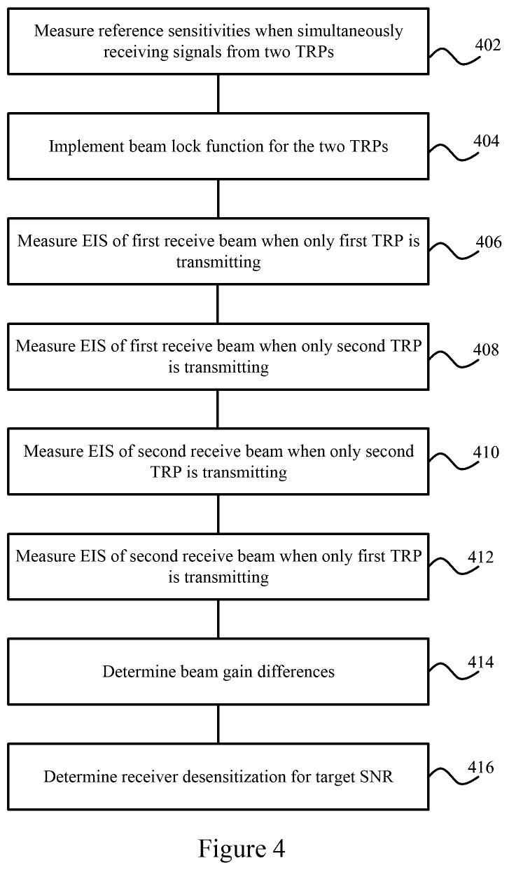

FIG. 4 illustrates an example of a method for determining receiver desensitization of a UE 104 in accordance with the second implementation. Steps of the method of FIG. 4 include measuring EIS of a receiver 214 when a UE 104 is simultaneously receiving first signal 212a from first TRP 202a and second signal 212b from second TRP 202b, as well as measuring EIS at times when the UE 104 is only receiving one of the two signals 212a and 212b. The first TRP 212a is located at a first direction (ϕ₁, θ₁) to the UE 104, and the second TRP 212b is located at a second direction (ϕ₂, θ₂) to the UE 104. The method of FIG. 4 may be initiated by the UE 104 or the network.

In some implementations, a beam (i,j) used to receive a signal 212a from the first TRP 212a alone may be different than a beam (i′,j′) used to receive the signal from the first TRP 202a when the UE 104 is simultaneously receiving signals 212a and 212b from the two TRPs 202a and 202b.

At 402, the UE 104 may measure reference sensitivities for EIS_{i,j}^{1′}(ϕ₁, θ₁) and EIS_{i,j}^{2′}(ϕ₂, θ₂) when simultaneously receiving a first signal 212a from first TRP 202a at (ϕ₁, θ₁) and a second signal 212b from second TRP 202b at (ϕ2, θ₂). Here, the reference sensitivities are presented with respect to the first antenna panel 206a (i) and the first receive beam 210a (j) and with respect to the second antenna panel 206b (k) and the second receive beam 210a (j). The reference sensitivity values may be used as baseline values for adapting receive beams 210 of the UE 104.

After measuring reference sensitivities at 402, a beam lock function may be implemented for the first and second receive beams of the UE 104. For example, a test equipment may transmit a signal indicating a desensitization process is being performed to the UE 104, and the UE 104 may implement a beam lock function to temporarily lock the first and second receive beams. In another implantation, the network is aware that the UE 104 is simultaneously receiving signals 212 from two TRPs 202 and communicates instructions including beam locking instructions to the UE 104. Other implementations are possible.

At 406, the UE 104 measures an EIS for the first TRP 202a using first receive beam 210a and first antenna panel 206a. This EIS may be measured when the UE 104 receives the first signal 212a from the first TRP 202a and does not receive the second signal 212b from the second TRP 202b. Accordingly, the EIS may be measured for the first TRP 202a without interference from the second signal 212b from the second TRP 202b. In some implementations, the EIS is measured when the second TRP 212b is not transmitting any signals that could be measured by the UE 104 as interference with the first signal 212a. For example, the EIS may be measured when the second TRP 202b is not transmitting any signals on frequencies associated with the second signal 212b in any direction, or when the second TRP 212b is not transmitting any signals at all. The result may be denoted by EIS_{i,j}¹(ϕ₁, θ₁).

At 408, the UE 104 measures an EIS for the second TRP 202b using the first receive beam 210a and the first antenna panel 206a. This EIS may be measured when the UE 104 receives the second signal 212b from the second TRP 202b and does not receive the first signal 212a from the first TRP 202a. Accordingly, the EIS may be measured for the second TRP 202b without interference from the first signal 212a from the first TRP 202a. In some implementations, the EIS is measured when the first TRP 212a is not transmitting any signals that could be measured by the UE 104 as interference with the second signal 212b. For example, the EIS may be measured when the first TRP 202a is not transmitting any signals on frequencies associated with the first signal 212a in any direction, or when the first TRP 212a is not transmitting any signals at all. The result may be denoted by EIS_{i,j}²(ϕ₂, θ₂).

At 410, the UE 104 measures an EIS for the second TRP 202b using the second receive beam 210b and the second antenna panel 206b. This EIS may be measured when the UE 104 receives the second signal 212b from the second TRP 202b and does not receive the first signal 212a from the first TRP 202a as discussed herein. Accordingly, the EIS may be measured for the second TRP 202b without interference from the first signal 212a from the first TRP 202a. The result may be denoted by EIS_{k,l}²(ϕ₂, θ₂).

At 412, the UE 104 measures an EIS for the first TRP 202a using the second receive beam 210b and the second antenna panel 206b. This EIS may be measured when the UE 104 receives the first signal 212a from the first TRP 202a and does not receive the second signal 212b from the second TRP 202b as discussed herein. Accordingly, the EIS may be measured for the first TRP 202a without interference from the second signal 212b from the second TRP 202b. The result may be denoted by EIS_{k,l}¹(ϕ₁, θ₁). The processes of 406, 408, 410, and 412 are not limited to the order presented in FIG. 4 and may be performed in a different order in various examples.

At 414, the UE 104 may compute beam gain differences for gains of the first and second receive beams 210a and 210b in directions of the first TRP 202a and the second TRP 202b. In particular, the UE 104 may compute the following differences in beam gain G based on differences of the EIS values measured at 406, 408, 410 and 412:

$$\begin{matrix}{G}_{i , j} ( {ϕ}_{1} , {θ}_{1} ) - {G}_{i , j} ( {ϕ}_{2} , {θ}_{2} ) = {EIS}_{i , j}^{1} ( {ϕ}_{1} , {θ}_{1} ) - {EIS}_{i , j}^{2} ( {ϕ}_{2} , {θ}_{2} ) \\ {G}_{k , l} ( {ϕ}_{2} , {θ}_{2} ) - {G}_{k , l} ( {ϕ}_{1} , {θ}_{1} ) = {EIS}_{k , l}^{2} ( {ϕ}_{2} , {θ}_{2} ) - {EIS}_{k , l}^{1} ( {ϕ}_{1} , {θ}_{1} ) \\ {G}_{i , j} ( {ϕ}_{1} , {θ}_{1} ) - {G}_{k , l} ( {ϕ}_{1} , {θ}_{1} ) = {EIS}_{i , j}^{1} ( {ϕ}_{1} , {θ}_{1} ) - {EIS}_{k , l}^{1} ( {ϕ}_{1} , {θ}_{1} ) \\ {G}_{k , l} ( {ϕ}_{2} , {θ}_{2} ) - {G}_{i , j} ( {ϕ}_{2} , {θ}_{2} ) = {EIS}_{k , l}^{2} ( {ϕ}_{2} , {θ}_{2} ) - {EIS}_{i , j}^{2} ( {ϕ}_{2} , {θ}_{2} )\end{matrix}$$

At 416, the UE 104 may determine receiver desensitization for a target SNR. The target SNR may be, for example, depend on the reference measurement channel. For a reference measurement channel using a large QAM constellation, such as 64-QAM or 256-QAM, and a high code rate, the SNR requirement to successfully demodulate the channel will be high. Conversely, for a reference measurement channel using a smaller QAM constellation, such as QPSK or 16-QAM, and a low code rate, the SNR requirement to successfully demodulate the channel will be low. In some implementations, the UE 104 may determine desensitization values associated with the first and second receive beams 210a and 210b to achieve the target SNR for receiving one or both of the signals from the first TRP 212a and the second TRP 212b. Accordingly, for a target SNR, the UE 104 may determine the receiver desensitization that results for first TRP 202a and second TRP 202b at directions (ϕ₁, θ₁) and (ϕ₂, θ₂) using the beam gain differences computed at 414 using equations 8 and 9.

In some implementations, the first desensitization and the second desensitization are based at least in part on a difference between a gain of the second receive beam in a direction of the second TRP 212b and a gain of the first receive beam in a direction of the second TRP 212b. In some implementations, the first desensitization and the second desensitization are based at least in part on a difference between a gain of the first receive beam 210b in the direction of the first TRP 202a and a gain of the second receive beam 210b in the direction of the first TRP 202a. For example, the first desensitization ΔEIS¹ may be determined as:

$$\begin{matrix}Δ {EIS}^{1} = 10 {log}_{10} ( \frac{1 + 1 {0}^{- A / 10}}{1 - 1 {0}^{- ( A + B ) / 10}} ) \\ where \\ A = {G}_{k , l} ( {ϕ}_{2} , {θ}_{2} ) - {G}_{i , j} ( {ϕ}_{2} , {θ}_{2} ) - SNR \\ B = {G}_{i , j} ( {ϕ}_{1} , {θ}_{1} ) - {G}_{k , l} ( {ϕ}_{1} , {θ}_{1} ) - SNR .\end{matrix}$$

The second desensitization ΔEIS² may be determined as:

$$\begin{matrix}Δ {EIS}^{2} = 10 {log}_{10} ( \frac{1 + 1 {0}^{- B / 10}}{1 - 1 {0}^{- ( A + B ) / 10}} ) \\ where \\ A = {G}_{k , l} ( {ϕ}_{2} , {θ}_{2} ) - {G}_{i , j} ( {ϕ}_{2} , {θ}_{2} ) - SNR \\ B = {G}_{i , j} ( {ϕ}_{1} , {θ}_{1} ) - {G}_{k , l} ( {ϕ}_{1} , {θ}_{1} ) - SNR .\end{matrix}$$

The desensitization values from 416 may be used by the UE 104 to adapt one or more parameter of at least one of the first receive beam 210a and the second receive beam 210b to improve reception from one or both of the first TRP 202a and the second TRP 202b. In some implementations, the UE 104 may adapt at least one of the first and second receive beams 210a and 210b to simultaneously reduce a first EIS for the first TRP 202a and reduce a second EIS for a the second TRP 202b. For example, the UE may adapt a direction of one or both of the receive beams 210a and 210b to improve simultaneous reception from both TRPs 202a and 202b. Adjusting a direction of a receive beam 210 may attenuate one signal 212 more than another signal 212 during simultaneous reception, thereby improving receiver performance. Alternatively, in the case that the UE 104 can only implement a set of fixed beams, the UE may choose a different set of beams during simultaneous reception from the two TRPs than when only receiving from the first TRP 202a or the second TRP 202b. Additionally, the beams gains G_{k,l}(ϕ₂, θ₂), G_{i,j}(ϕ₂, θ₂), G_{i,j}(ϕ₁, θ₁) G_{k,l}(ϕ₁, θ₁) may be chosen to maximize A and B and thus minimize the receiver desensitizations ΔEIS¹ and ΔEIS¹.

In some implementations, the UE 104 may adjust a beam parameter such as a direction of one or both of the first and second receive beams 210a and 210b and repeat at least some of the steps of FIG. 4 after changing the one or more beam directions to evaluate the effects of changing receive beam directions on simultaneous reception from two TRPs. Persons of skill in the art will recognize that aspects of the present disclosure may be used in these and other ways to improve performance of a UE within a wireless telecommunications network

In some implementations, the UE 104 may transmit at least some of the information gathered in the process of FIG. 4 to the network. In one implementation, the UE 104 transmits at least one of a first desensitization value associated with a first receive beam 210a, a second desensitization value associated with a second receive beam 210b, and the target SNR value to an NE 102. The NE 102 may be one of the first and second TRPs 212a and 212b, or a different entity. This information may inform the network of limits on the performance of the UE 104 and/or how the links will perform. The network may use this information to assist with scheduling decisions for scheduling transmissions to the UE 104. Persons of skill in the art will recognize that these and other advantages are possible according to aspects of the present disclosure.

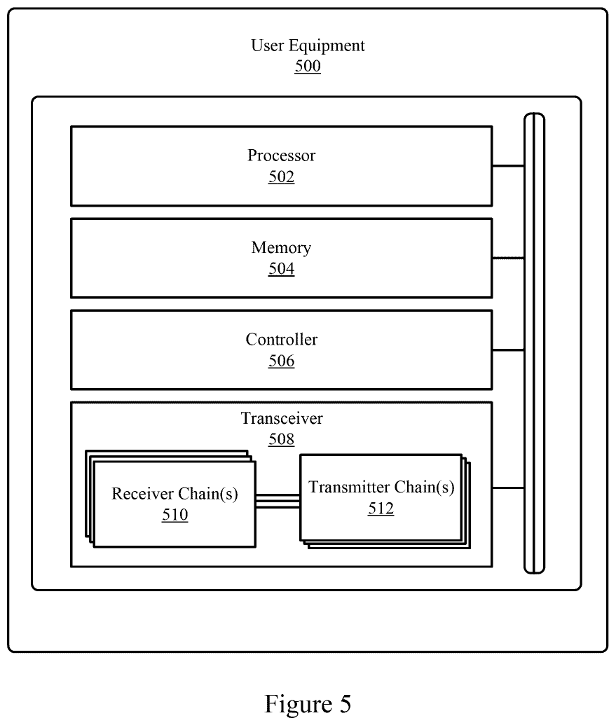

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for determining desensitization of receive beams of a UE 104.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

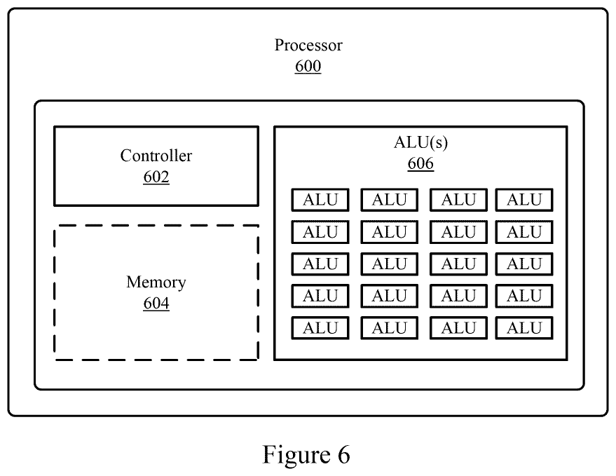

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for determining desensitization of receive beams of a UE 104.

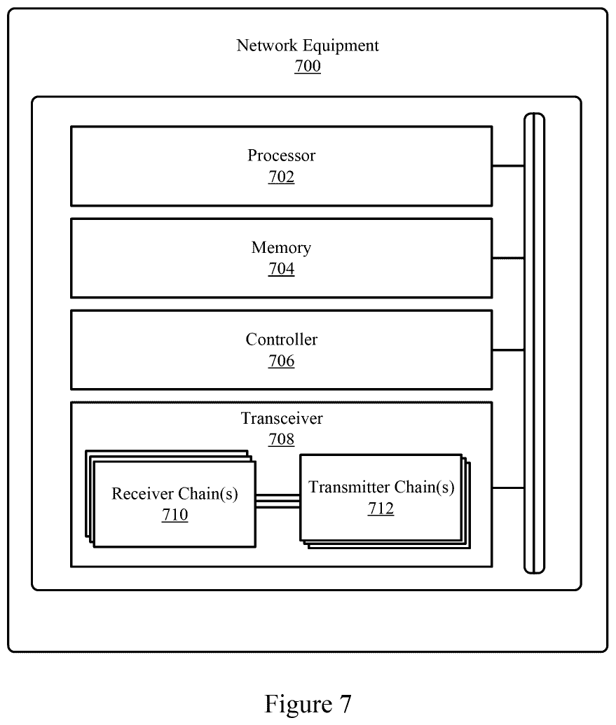

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to support a means for determining desensitization of receive beams of a UE 104.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or a wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

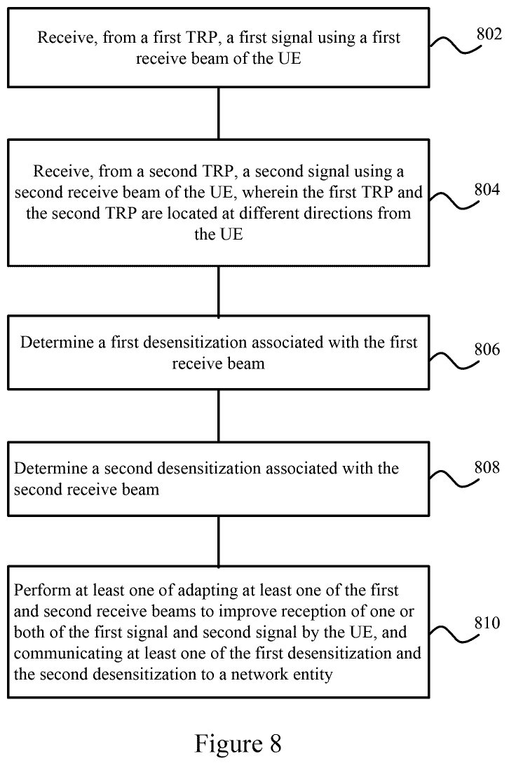

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include receiving, from a first TRP, a first signal using a first receive beam of the UE. The operations of 802 may be performed in accordance with examples as described herein. In some implementations, aspects of the operations of 802 may be performed by a UE as described with reference to FIG. 5.

At 804, the method may include receiving, from a second TRP, a second signal using a second receive beam of the UE, wherein the first TRP and the second TRP are located at different directions from the UE. The operations of 804 may be performed in accordance with examples as described herein. In some implementations, aspects of the operations of 804 may be performed by a UE as described with reference to FIG. 5.

At 806, the method may include determining a first desensitization associated with the first receive beam. The operations of 806 may be performed in accordance with examples as described herein. In some implementations, aspects of the operations of 806 may be performed a UE as described with reference to FIG. 5.

At 808, the method may include determining a second desensitization associated with the second receive beam. The operations of 808 may be performed in accordance with examples as described herein. In some implementations, aspects of the operations of 808 may be performed a UE as described with reference to FIG. 5.

At 810, the method may include performing at least one of adapting at least one of the first and second receive beams to improve reception of one or both of the first signal and second signal by the UE, and communicating at least one of the first desensitization and the second desensitization to a network entity. The operations of 810 may be performed in accordance with examples as described herein. In some implementations, aspects of the operations of 810 may be performed a UE as described with reference to FIG. 5.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively configured to cause the UE to:
receive, from a first transmission reception point (TRP), a first signal using a first receive beam of the UE;
receive, from a second TRP, a second signal using a second receive beam of the UE, wherein the first TRP and the second TRP are located at different directions from the UE;
determine a first desensitization associated with the first receive beam;
determine a second desensitization associated with the second receive beam; and
perform at least one of adapting at least one of the first and second receive beams to improve reception of one or both of the first signal and second signal by the UE, and communicating at least one of the first desensitization and the second desensitization to a network entity.

2. The UE of claim 1, wherein the one or more processors are further individually or collectively configured to cause the UE to adapt the at least one of the first and second receive beams to simultaneously reduce a first Effective Isotropic Sensitivity (EIS) for the first TRP and reduce a second EIS for the second TRP.

3. The UE of claim 1, wherein the first desensitization and the second desensitization are based at least in part on a difference between a gain of the second receive beam in a direction of the second TRP and a gain of the first receive beam in a direction of the second TRP.

4. The UE of claim 3, wherein the difference between the gain of the second beam in the direction of the second TRP and the gain of the first beam in the direction of the second TRP is a difference between:
a first EIS for the second TRP measured when the UE receives the second signal from the second TRP using the first beam and does not receive the first signal from the first TRP, and
a second EIS for the second TRP measured when the UE receives the second signal from the second TRP using the second beam and does not receive the first signal from the first TRP.

5. The UE of claim 3, wherein the first desensitization and the second desensitization are based at least in part on a difference between a gain of the second receive beam in the direction of the second TRP and a gain of the first receive beam in the direction of the second TRP.

6. The UE of claim 1, wherein the first desensitization ΔEIS¹ is determined as:
$$Δ {EIS}^{1} = 10 {log}_{10} ( \frac{1 + 1 {0}^{- A / 10}}{1 - 1 {0}^{- ( A + B ) / 10}} )$$
$$where$$
$$\begin{matrix}A = {G}_{k , l} ( {ϕ}_{2} , {θ}_{2} ) - {G}_{i , j} ( {ϕ}_{2} , {θ}_{2} ) - SNR \\ B = {G}_{i , j} ( {ϕ}_{1} , {θ}_{1} ) - {G}_{k , l} ( {ϕ}_{1} , {θ}_{1} ) - SNR ,\end{matrix}$$
SNR is a signal-to-noise ratio, G_{i,j}(ϕ₁, θ₁) is a gain of the first receive beam j of an antenna panel i in the direction of the first TRP, G_{i,j}(ϕ₂, θ₂) is a gain of the first receive beam in the direction of the second TRP, G_{k,l}(ϕ₁, θ₁) is a gain of the second receive beam l of an antenna panel k in the direction of the first TRP, and G_{k,l}(ϕ₂, θ₂) is a gain of the second receive beam in the direction of the second TRP.

7. The UE of claim 1, wherein the second desensitization ΔEIS² is determined as:
$$Δ {EIS}^{2} = 10 {log}_{10} ( \frac{1 + 1 {0}^{- B / 10}}{1 - 1 {0}^{- ( A + B ) / 10}} )$$
$$where$$
$$\begin{matrix}A = {G}_{k , l} ( {ϕ}_{2} , {θ}_{2} ) - {G}_{i , j} ( {ϕ}_{2} , {θ}_{2} ) - SNR \\ B = {G}_{i , j} ( {ϕ}_{1} , {θ}_{1} ) - {G}_{k , l} ( {ϕ}_{1} , {θ}_{1} ) - SNR ,\end{matrix}$$
SNR is a signal-to-noise ratio, G_{i,j}(ϕ₁, θ₁) is a gain of the first receive beam j of an antenna panel i in the direction of the first TRP, G_{i,j}(ϕ₂, θ₂) is a gain of the first receive beam in the direction of the second TRP, G_{k,l}(ϕ₁, θ₁) is a gain of the second receive beam l of an antenna panel k in the direction of the first TRP, and G_{k,l}(ϕ₂, θ₂) is a gain of the second receive beam in the direction of the second TRP.

8. The UE of claim 1, wherein the first signal and the second signal are in frequency range FR2.

9. The UE of claim 1, wherein the one or more processors are further individually or collectively configured to cause the UE to:
measure a first reference EIS for the first TRP; and
measure a second reference EIS for the second TRP,
wherein the first EIS and the second EIS are measured when the UE simultaneously receives the first signal from the first TRP and the second signal from the second TRP.

10. The UE of claim 9, wherein the one or more processors are further individually or collectively configured to cause the UE to:
implement a beam lock function after measuring the first reference EIS and the second reference EIS wherein the signal from the first TRP is received using the first receive beam of a first antenna panel and the signal from the second TRP is received using the second receive beam of a second antenna panel.

11. The UE of claim 10, wherein the one or more processors are further individually or collectively configured to cause the UE to, while the beam lock function is active:
measure a first EIS of the first signal from the first TRP using the first receive beam of the first antenna panel when the second signal is not being received from the second TRP; and
measure a second EIS of the second signal from the second TRP using the second beam of the second antenna panel when the first signal is not being received from the first TRP.

12. A method performed by a user equipment (UE), the method comprising:
receiving, from a first transmission reception point (TRP), a first signal using a first receive beam of the UE;
receiving, from a second TRP, a second signal using a second receive beam of the UE, wherein the first TRP and the second TRP are located at different directions from the UE;
determining a first desensitization associated with the first receive beam;
determining a second desensitization associated with the second receive beam; and
performing at least one of adapting at least one of the first and second receive beams to improve reception of one or both of the first signal and second signal by the UE, and communicating at least one of the first desensitization and the second desensitization to a network entity.

13. The method of claim 12, further comprising:
adapting the at least one of the first and second receive beams to simultaneously reduce a first Effective Isotropic Sensitivity (EIS) for the first TRP and reduce a second EIS for the second TRP.

14. The method of claim 12, wherein the first desensitization and the second desensitization are based at least in part on a difference between a gain of the second receive beam in a direction of the second TRP and a gain of the first receive beam in a direction of the second TRP.

15. The method of claim 14, wherein the difference between the gain of the second beam in the direction of the second TRP and the gain of the first beam in the direction of the second TRP is a difference between:
a first EIS for the second TRP measured when the UE receives the second signal from the second TRP using the first beam and does not receive the first signal from the first TRP, and
a second EIS for the second TRP measured when the UE receives the second signal from the second TRP using the second beam and does not receive the first signal from the first TRP.

16. The method of claim 14, wherein the first desensitization and the second desensitization are based at least in part on a difference between a gain of the second receive beam in the direction of the second TRP and a gain of the first receive beam in the direction of the second TRP.

17. The method of claim 12, wherein the first desensitization ΔEIS¹ is determined as:
$$Δ {EIS}^{1} = 10 {log}_{10} ( \frac{1 + 1 {0}^{- A / 10}}{1 - 1 {0}^{- ( A + B ) / 10}} )$$
$$where$$
$$\begin{matrix}A = {G}_{k , l} ( {ϕ}_{2} , {θ}_{2} ) - {G}_{i , j} ( {ϕ}_{2} , {θ}_{2} ) - SNR \\ B = {G}_{i , j} ( {ϕ}_{1} , {θ}_{1} ) - {G}_{k , l} ( {ϕ}_{1} , {θ}_{1} ) - SNR ,\end{matrix}$$
SNR is a signal-to-noise ratio, G_{i,j}(ϕ₁, θ₁) is a gain of the first receive beam j of an antenna panel i in the direction of the first TRP, G_{i,j}(ϕ₂, θ₂) is a gain of the first receive beam in the direction of the second TRP, G_{k,l}(ϕ₁, θ₁) is a gain of the second receive beam l of an antenna panel k in the direction of the first TRP, and G_{k,l}(ϕ₂, θ₂) is a gain of the second receive beam in the direction of the second TRP.

18. The method of claim 12, wherein the second desensitization ΔEIS² is determined as:
$$Δ {EIS}^{2} = 10 {log}_{10} ( \frac{1 + 1 {0}^{- B / 10}}{1 - 1 {0}^{- ( A + B ) / 10}} )$$
$$where$$
$$\begin{matrix}A = {G}_{k , l} ( {ϕ}_{2} , {θ}_{2} ) - {G}_{i , j} ( {ϕ}_{2} , {θ}_{2} ) - SNR \\ B = {G}_{i , j} ( {ϕ}_{1} , {θ}_{1} ) - {G}_{k , l} ( {ϕ}_{1} , {θ}_{1} ) - SNR ,\end{matrix}$$
SNR is a signal-to-noise ratio, G_{i,j}(ϕ₁, θ₁) is a gain of the first receive beam j of an antenna panel i in the direction of the first TRP, G_{i,j}(ϕ₂, θ₂) is a gain of the first receive beam in the direction of the second TRP, G_{k,l}(ϕ₁, θ₁) is a gain of the second receive beam l of an antenna panel k in the direction of the first TRP, and G_{k,l}(ϕ₂, θ₂) is a gain of the second receive beam in the direction of the second TRP.

19. The method of claim 12, wherein the first signal and the second signal are in frequency range FR2.

20. The method of claim 12, further comprising:
measuring a first reference EIS for the first TRP;
measuring a second reference EIS for the second TRP; and
implementing a beam lock function after measuring the first reference EIS and the second reference EIS,
wherein the first EIS and the second EIS are measured when the UE simultaneously receives the first signal from the first TRP and the second signal from the second TRP.
